(19) United States
(12) Patent Application Publication
(10) Pub. No.: US 2007/0135613 A1
(43) Pub. Date: Jun. 14, 2007

(54) Method for the manufacture of a partially crystalline polycondensate

(76) Inventors: Andreas Christel, Zuzwil (CH); Brent Allan Culbert, Wil (CH); Theodor Jurgens, Casstrop-Rauxel (DE)

Correspondence Address: Francis C Hand;Carella Byrne Bain Gilfillan Cecchi Stewart, & Olstein, 5 Becker Farm Road, Roseland, NJ, 07068, US

(21) Appl. No.: 10/590,554

(22) PCT Filed: Jan. 24, 2005
(86) PCT No.: PCT/CH05/00035

§ 371 Date: Aug. 24, 2006

(30) Foreign Application Priority Data
Mar. 12, 2004 (DE) 10 2004 012 579.1

(51) Int. Cl. C08G 63/02

(52) U.S. Cl. 528/272; 528/310

(57) ABSTRACT

The invention relates to a method for production of a partly-crystalline polycondensate, in particular, a polyester or a polyamide, whereby a polycondensate prepolymer is firstly produced, which is prepared and formed into granules, by means of a die-face granulating device, with an average diameter of less than 2 mm, said granules being cut at the outlet from the die plate. The degree of crystallisation and the molecular weight are then increased in a solid-phase polycondensation process. For granulation, the polycondensate prepolymer melt is pressed through a die plate with a number of die perforations, preferably arranged on at least one annular track. The cutting is achieved by means of a circulating knife with a liquid jet.

The invention relates to a method for the manufacture of a partially crystalline polycondensate, especially a polyester or polyamide, with the following steps:
a) Manufacture of a polycondensate prepolymer melt;
b) Formation of granulates and solidification of the polycondensate prepolymer melt, by means of a granulation device, wherein the granulates are cut at the exit from a nozzle of the granulation device;
c) Raising of the degree of crystallization of the prepolymer granulates; and
d) Raising the molecular weight of the granulates by means of solid phase polycondensation.

### MOST RECENT BACKGROUND ART

WO 01/42334 (Schiavone) describes a method, that optimizes PET manufacture so that a preform with improved properties can be produced, which is achieved by the addition of a high proportion of comonomer. An optimization relative to particle manufacturing process is however not performed and the possibility of producing improved properties by the right choice of particle size is not recognized. Thus the process is limited to polyethylene terephthalate with high copolymer proportion, which on the one hand has a negative influence on the treatment in the SSP and on the other hand limits the service range of the PET thus manufactured.

DE 198 49 485, Geier et al and DE 100 19 508 Matthaei et al respectively describe a method for the dropping and crystallization of polyesters in a drop tower. In the drop tower there is however the risk individual granulates collide with each other and stick together. The only possibility of implementing such a method comprises increasing the drop separation distance so much that the granulate collisions are reduced to an acceptably small amount. The resulting ratio of apparatus size (diameter of the drop nozzle and of the drop tower) to an achievable performance is so large that, for a commercial scale installation, a multiplicity of expensive drop towers must be operated in parallel.

### THE INVENTION

On the other hand it is a goal of the present invention to provide a method that is employable for a multiplicity of polycondensates that in contrast the state of the art achieves improved product properties and can be carried out efficiently with simpler technologies.

This object is solved by means of the method in accordance with claim 1 in which in the initially mentioned method in accordance with the invention in step b) granulates having a mean diameter of less than 2 mm are formed.

Thereby a sufficiently large surface/volume ratio of the granulate particles is ensured, whereby the diffusion amount per unit time is large and a rapid IV increase or molecular weight increase of the polycondensate can take place. Furthermore, degradation reactions of the polycondensate can thereby be to a large extent suppressed.

Preferably in step b) granulates with a mean diameter of 0.4-1.7 mm, especially 0.6-1.2 mm, are formed.

For this purpose the polycondensate prepolymer melt can be pressed through a nozzle plate with a multiplicity of nozzle holes, which preferably are arranged in at least one annular path.

The cutting in the granulation step b) can be carried out by means of a circumferential knife.

Preferably the cutting takes place in the granulation step b) by means of a fluid jet, especially by means of a liquid jet.

For the polyester it is a question of a polyethyleneterephthalate, a polybutyleneterephthalate or one of their copolymers.

Preferably in the case of the polycondensate prepolymer melt we are dealing with a polyester melt, especially the melt of a polyethyleneterephthalate or one of its copolymers with a degree of polymerization consistent with an IV value of 0.18 to 0.45 dl/g.

Preferably, upon entry into crystallization step c), the prepolymer granulate has a crystallinity of less than 10%.

The crystallization step c) can take place in a fluid bed or fluidized bed by the action of a fluidizing gas.

Preferably the average temperature of the prepolymer granulates (in ° C.) in the transition from the granulation step b) to the crystallization step c) should not be allowed to fall under a value of ¼ the melting temperature (in ° C.).

In the granulation step b) a liquid can be used for the cutting which is mostly detached from the prepolymer granulates, before they go to the crystallization step c), wherein especially water is used as liquid.

In the polycondensate a copolymer of polyethyleneterephthalate can be involved, wherein the dicarboxylic acid component comprises more than 96 mol % terephthalic acid and the diol component comprises more than 94% or less than 84 mol % of ethyleneglycol.

The polycondensate can involve a copolymer of polyethyleneterephthalate, wherein the diol component comprises more than 98 mol % of ethyleneglycol.

The polycondensate can involve a copolymer of polyethyleneterephthalate, wherein the dicarboxylic acid component comprises 96 to 99 mol % of terephthalic acid.

Preferably simultaneously with the crystallization step c), heating to a suitable temperature for the solid phase polycondensation takes place.

Porous granulate can also be produced, in which the prepolymer melt, preferably in step a) and/or in step b) employs a foaming agent.

Other advantages, features and application possibilities of the invention arise from the following non-limiting comprehensive description.

Polycondensate

The polycondensate involves a crystallizable thermoplastic polycondensate, such as for example polyamides, polyesters, polycarbonates or polylactides, which is produced by means of a polycondensation reaction by splitting off a low molecular weight reaction product. The polycondensation can take thereby place directly between the monomers or via an intermediate stage, which is reacted to connect through transesterification, wherein the transesterification can again take place by splitting off a low molecular weight reaction product or by ring-opening polymerization. The polycondensate thus produced is essentially linear, wherein a small amount of branching can come into being.

In the case of polyamides a polymer is involved which by means of polycondensation of its monomers, either a diamine component and a dicarboxylic acid component or a bifunctional monomer with an amine and a carboxylic acid group is produced.

In the case of polyesters a polymer is involved which through polycondensation of its monomers, a diol component and a dicarboxylic acid component is produced. Different, mostly linear or cyclic diol components go into action. Likewise different, mostly aromatic dicarboxylic acid components go into use. Instead of the dicarboxylic acids their corresponding dimethyl esters can also be employed.

Typical examples of polyesters are polyethyleneterephthalate (PET), polybutyleneterephthalate (PBT) and polyethylenenaphthalate (PEN) which can go into action either as homopolymers or as copolymers.

In an embodiment the polyester is comprised of a copolymer of polyethyleneterephthalate wherein either:
the diol component comprises more than 98 mol % of ethylene glycol, or
the dicarboxylic acid component comprises more than 96 mol % terephthalic acid and the diol component comprises more than 94 mol % or less than 84 mol % of ethylene glycol, or
the dicarboxylic acid component comprises 96 to 99 mol % terephthalic acid.

Prepolymer Melt

In a first step the polycondensate monomers are polymerized or polycondensed to a prepolymer in the liquid phase. Conventionally the preparation of the prepolymer melt takes place in a continuous process, wherein an esterification stage follows a prepolycondensation stage. The polycondensation stages used in the conventional polyester manufacturing process do not take place in the high viscosity reactor (also called Finisher) (Compare: Modern Polyesters, Wiley series in Polymer Science, Edited by John Scheirs, J. Wiley & Sons Ltd, 2003; FIG. 2.37+L).

The Degree of Polymerization (DP) achieved there is still distinctly lower under the polymerization degree of polycondensate after the subsequent solid phase treatment. Usually the degree of polymerization of the prepolymer is under 60%, especially under 50% of the degree of polymerization of the polycondensate postcondensed in the solid phase. Preferentially the degree of polymerization of the prepolymer lies between 10 and 50, especially between 25 and 40.

In the case of PET a degree of polymerization analogous to an IV value of 0.18 to 0.45 dl/g is achieved. For PET an IV value between 0.30 and 0.42 dl/g is preferred. For the calculation of the degree of polymerization from the IV value of a PET the relationship DP=155.5*IV^{1.466} from U.S. Pat. No. 5,532,333, Stouffer et al is used.

The process customarily takes place at elevated temperature, whereby the prepolymer is formed as a prepolymer melt. The prepolymer melt can however also be produced by heating up a previously solidified prepolymer. Mixtures of different prepolymers may also be considered as prepolymer melt, wherein also recycled crude materials can be employed.

The prepolymer melt can contain various additives, such as for example catalysts, stabilizers, coloring additives, reactive chain-lengthening additives, and so forth.

Granulation

For the granulation the prepolymer melt is pressed through a nozzle having a multiplicity of openings and subsequently cut. The nozzle preferably comprises at least one nozzle body and a nozzle plate. In the nozzle body the prepolymer melt is distributed on the nozzle plate area in which the openings are located, wherein measures for uniform distribution, tempering and flow rate are found. In the nozzle plate a plurality of openings (nozzle holes) are located, through which the prepolymer melt flows. The hole dimensions are frequently constant over the entire nozzle plate.

In order to equalize irregularities in flow through the openings it can be advantageous, depending on position of the openings, to provide different opening lengths and opening diameters. The openings can be made wider on the inlet side. On the outlet side a straight cutting edge is an advantage, wherein here also a widening and/or rounding off of the opening is conceivable.

The nozzle plate must be heated sufficiently (e.g. electrically or with a heat carrying medium), in order to prevent flash-freezing of the prepolymer melt and thereby blocking of the openings. At the same time the exterior side of the nozzles should be isolated in order to decrease the loss of heat.

The nozzle plate can consist e.g. of metal, ceramic or a combination of metal and ceramic. The openings are usually round, but can have another profile such as for example slit-shaped openings.

The resulting granulates are for example spherically shaped or ball-like, lens-shaped or cylinder shaped. Also porous granulates are conceivable, for example when the prepolymer melt is treated with a foaming agent (gas or gas-producing chemical foaming agent).

The granulate size, measured as a mean diameter of individual granulates, should be smaller than 2 mm, preferably 0.4-1.7 mm, especially 0.6-1.2 mm.

The cutting should take place in accordance with the invention at the nozzle outlet. For the cutting a rotary cutting device such as for example a rotating cutter head can be used. On the cutter head one or a plurality of cutting elements (e.g. knifes) are fastened, which separate the prepolymer melt exiting from the nozzle openings. Between the nozzle plate and the cutting elements there can be a small separation, so as to prevent constantly “grinding” of the cutting elements on the nozzle plate. The cutting elements can be made of various materials, such as for example, metal, glass or ceramic, wherein however the metal knifes are preferred.

The separation can also be carried out in accordance with the invention by means of one or a plurality of high pressure fluid jets or liquid jets (water jet cutting system, jet cutting). Optionally an abrasive cutting agent can be added.

Also a combination of gas jet and liquid jet can be used as cutting “mixed fluid jet”.

Furthermore, the granulation can be carried out by employing one or a plurality of laser jets (laser jet cutting or laser cutting).

The number of holes and the cutting frequency must be adjusted depending on the throughput of the desired granulate size, wherein through employing a plurality of cutting elements the cutting frequency can be a multiple of the frequency of circulation of the cutting device. The following table presents the resulting strong dependence:

| | granulate size diameter | | | | | | | | | | | |
|---|---|---|---|---|---|---|---|---|---|---|---|---|
| | 0.5 mm | | | 1 mm | | | 1.5 mm | | | 2 mm | | |
| cutting | 40 | 200 | 800 | 40 | 200 | 800 | 40 | 200 | 800 | 40 | 200 | 800 |
| frequency | | | | | | | | | | | | |
| [Hz] | | | | | | | | | | | | |
| throughput | 0.01 | 0.06 | 0.25 | 0.1 | 0.5 | 2 | 0.33 | 1.7 | 6.7 | 0.8 | 4 | 16 |
| per hole | | | | | | | | | | | | |
| [kg/(h*hole)] | | | | | | | | | | | | |

Preferred are throughputs of 0.1-2 kg/(h*hole) and cutting frequencies of 80-400 Hz.

In order to prevent sticking together of the cut granulates, these are immediately surrounded by a liquid. For that the granulation can take place in the liquid, or the granulates can be centrifuged in a liquid ring.

Suitable granulation devices are known under the term “head granulation” or “hot face granulation”, “under water granulation” and “water ring granulation”.

Despite use of the term “water” in the designation of the granulation devices, other fluids, fluid mixtures, liquids, liquid mixtures or liquids with dissolved emulsified or suspended substances are used.

The fluid or the liquid is usually at least partially used in a loop in which the conditions (temperature, pressure, composition) are sustained for a regenerated application for the granulation.

The polycondensation melt solidifies upon cooling. This preferably occurs by means of the liquid used in the granulation process. The use of other cooling media or the combination of a plurality of cooling media is however conceivable.

The cooling down can take place at a temperature which lies under the glass transition temperature of the polycondensate which allows the storage and/or transportation of the granulates over a longer time period.

The average temperature of the precondensate granulates can also however be held at a higher level in order to improve the energy efficiency of the process. For that it is possible to raise the temperature of the cooling medium and/or to choose the holding time in the cooling medium correspondingly short (shorter than 5 seconds, especially shorter than 2 seconds).

The average granulate temperature (in ° C.) should thereby be greater than ¼ Tm_{PrP}, especially ⅓ Tm_{PrP}, wherein Tm_{PrP} represents the melting temperature (in ° C.) of the polycondensate prepolymer.

While the prepolymer granulate is in contact with the liquid, at least partial crystallization can take place. Preferably the contact conditions (temperature and time) between prepolymer granulate and liquid are chosen so that essentially no adverse effect on the reaction rate occurs in the subsequent solid phase polycondensation process.

For example the contact time of a PET prepolymer in water at a temperature between 1 and 25° C. under the boiling point should not amount to more than 10 minutes, preferably not more than 2 minutes.

Accomplishing the present invention provides that the contact conditions are chosen so that the degree of crystallization of the polymer granulate amounts to less than 10% before entry into the subsequent crystallization step.

Crystallization

Raising the degree of crystallization of the prepolymer granulates takes place according to the known state of the art method. For that the prepolymer granulates must be treated at a suitable crystallization temperature. In the crystallization at least a degree of crystallization should be achieved which permits treatment in the subsequent solid phase polycondensation, without the occurrence of sticking together or formation of clumps, and which lies significantly above the degree of crystallization of the polycondensate cooled through quenching.

The suitable temperature range is evident if the crystallization half-period (t_{1/2}) recorded as a function of temperature. It is limited above and below through the temperature at which the crystallization half-period reaches approximately 10 times the minimal crystallization half-period. Since very short crystallization half-periods (t_{1/2}) are difficult to determine, t_{1/2}=1 minute is established as a minimal value.

For PET the temperature range lies between 100 and 220° C., and a degree of crystallization of at least 20%, preferably at least 30%, is achieved.

After achieving a partial crystallization, the granulate can be brought to a temperature outside the crystallization temperature range. Cooling down to a temperature below the crystallization range should however preferably be avoided.

If the temperature of the prepolymer granulate lies below the suitable crystallization temperature after they are separated from the liquid used in the granulation process, then the prepolymer granulates must be heated up. This can for example be carried out by means of a heated wall of the crystallization reactor, by way of heated components in the crystallization reactor, by radiation or by means of bubbling in a hot process gas.

The suitable crystallization time follows from the time needed to heat the product to the crystallization temperature, plus at least the crystallization half-period at the given temperature, wherein preferably 2 to 20 half-periods are taken for the heat-up time, in order to achieve sufficient mixing between crystalline and amorphous product.

In order to avoid the crystallizing polymer granulates sticking together these should be kept in motion relative to each other. This can be carried out for example by means of an agitator, a moving container or the action of a fluidizing gas.

Especially suitable crystallization reactors are fluid bed or fluidized bed crystallizers, since these do not tend to form dust.

At the same time as the increase of the degree of crystallization, possible residues of the liquid are removed from the granulating process.

If a process gas is used in the crystallization process loop, in order to prevent excessive adsorption of the liquid sufficient fresh gas or purified process gas must be added. The process gases used in the solid phase polycondensation can also be employed in the crystallization stage, wherein different process gases can also be employed in the different process stages.

Solid Phase Polycondensation

The molecular weight of the polycondensate granulates is brought to a higher degree of polymerization through a solid phase polycondensation, wherein at least a 1.67-fold, especially at least a 2-fold increase of the degree of polymerization occurs. For PET an increase of the IV value of at least 0.6 dl/g results, usually of at least 0.7 dl/g.

The solid phase polycondensation takes place according to known state of the art Methods and comprises at least the steps of heating up to a suitable postcondensation temperature and the postcondensation reaction. Optionally other steps can take place prior to the crystallization or subsequent cooling. Thereby continuous as well as batch processes can be utilized, which for example take place in apparatuses such as fluid bed, bubble fluidization or solid bed reactors as well as in reactors with agitation devices or self-moving reactors like rotary furnaces or rocking vessels.

The solid phase polycondensation can be carried out at elevated pressure or under vacuum as well as at normal pressure.

In the known state of the art methods, in which the step of heating up and the step of post condensation reaction by action of a process gas take place, the separation between the step of heating up and the step of post condensation reaction it is thereby provided that the step of heating up is carried out with a high quantity of gas (mg/mp=2-15, especially 2.5-10), whereby the temperature of the product essentially approaches the temperature of the gas, and that the post condensation reaction step is carried out with a lower amount of gas (mg/mp=0.1-1, especially 0.3-0.8), whereby the temperature of the gas essentially approximates the temperature of the product. Thereby mp is the sum of all product streams fed to the process, and mg is the sum of all the gas streams fed to the process.

As process gas, air or inert gases such as for example nitrogen or CO₂ as well as mixtures of process gases come into consideration, The process gas can contain additives, which either actively react with the treated product or are deposited passively onto the product to be treated. Preferably the process gas is at least partially fed into a loop.

In order to decrease an adverse effect to the polycondensation reaction, the process gas can be purified from undesirable products, especially cleavage products from the polycondensation reaction. Typical cleavage products like water, diols (e.g. ethyleneglycol, butanediol), diamines or aldehydes (e.g. acetaldehyde) should be reduced thereby to levels under 100 ppm, especially to levels under 10 ppm. The purification can be carried out by means of known state of the art gas purification systems like for example catalytic combustion systems, gas washing, adsorption systems or cold traps.

The suitable postcondensation temperature lies in a temperature range which is limited on the low side by a minimal reaction rate of the polycondensation and at the upper end is limited by a temperature which lies slightly below the melting temperature of the polycondensate. As minimal reaction rate the reaction rate is considered with which the desired increase of the degree of polymerization can be achieved in an economically acceptable time period.

For PET the post condensation temperature lies in the range from 190° C. to 245° C. The polycondensation conditions should be chosen so that the granulate can subsequently be processed to the end product under the most sparing conditions. The corresponding interrelationships for the manufacture of PET are for example explained in the application PCT/CH03/00686 which is included herewith.

The suitable post condensation time lies in the range from 2-100 hours, wherein based on efficiency grounds holding times of 6-30 hours are preferred.

Optionally the crystallization step and the heat-up step can take place at a suitable post condensation temperature simultaneously or at least in the same reactor, wherein the reactor utilized for that can be divided into a plurality of process chambers, in which different process conditions (e.g. temperature and holding time) can prevail. It is an advantage thereby if the heat-up rate at which the polycondensate is heated into the post condensation temperature range is sufficiently large in order to prevent excessive crystallization before the beginning of the polycondensation reaction. For PET the heat-up rate should be at least 10° C./min, preferably at least 50° C./min.

Product Manufacture

Following completion of the solid phase polycondensation the polycondensates can be processed to various products such as, for example fibers, bands, films or injection molded parts.

PET is in large measure processed to hollow bodies such as for example bottles.

1. A method for the manufacture of a partially crystalline polycondensate, especially a polyester or polyamide, comprising the following steps:
a) Manufacture of a polycondensate prepolymer melt;
b) Formation of granulates and solidification of the polycondensate-pre-polymer melt, by means of a granulation device, wherein the granulates is cut upon exit from a nozzle of the granulation device;
c) Raising of the degree of crystallization of the prepolymer granulates; and
d) Raising the molecular weight of the granulates by means of solid phase polycondensation,
characterized in that in the step b), granulates with a mean diameter of less than 2 mm are formed.

2. The method according to claim 1, characterized in that in the step b), granulates with a mean diameter of 0.4-0.7 mm, especially 0.6-1.2 mm are formed.

3. The method according to one of the preceding claims, characterized in that, the polycondensate prepolymer melt is pressed through a nozzle plate with a multiplicity of nozzle holes, which preferably are arranged on at least one annular pathway.

4. The method according to one of the preceding claims, characterized in that, the cutting in the granulation step b) is carried out with a circumferential knife.

5. The method according to one of the preceding claims, characterized in that, the cutting in the granulation step b) is carried out with a fluid jet, especially with a liquid jet.

6. The method according to one of the preceding claims, characterized in that the polyester involves a polyethyleneterephthalate, a polybutyleneterephthalate, a polyethylenenaphthalate or one of their copolymers.

7. The method according to one of the preceding claims, characterized in that the polycondensate prepolymer melt involves a polyester melt, especially the melt of a polyethyleneterephthalate or one of its copolymers with a degree of polymerization consistent with an IV value of 0.18 to 0.45 dl/g.

8. The method according to one of the preceding claims, characterized in that the prepolymer granulates upon entry into the crystallization step c) have a crystallinity of less than 10%.

9. The method according to one of the preceding claims, characterized in that the crystallization step c) is carried out in a fluid bed or fluidized bed reactor with the action of a fluidizing gas.

10. The method according to one of the preceding claims, characterized in that the average temperature of the prepolymer granulates (in ° C.) in the transition from granulation step b) to crystallization step c) does not fall under a value corresponding to ¼ of the melting temperature Tm_{PrP} (in ° C.).

11. The method according to one of the preceding claims, characterized in that in the granulation step b) a liquid is used for the cutting, which is mostly separated from the prepolymer granulates, before they are fed to the crystallization step c).

12. The method according to one of the preceding claims, characterized in that water is used as liquid.

13. The method according to one of the preceding claims, characterized in that the polycondensate involves a copolymer of polyethyleneterephthalate, wherein the dicarboxylic acid component comprises more than 94 mol % or less than 84 mol % ethyleneglycol.

14. The method according to one of the preceding claims, characterized in that the polycondensate involves a copolymer of polyethyleneterephthalate, wherein the diol component comprises more than 98 mol % ethyleneglycol.

15. The method according to one of the preceding claims, characterized in that the polycondensate involves a copolymer of polyethyleneterephthalate, wherein the dicarboxylic acid component comprises 98 mol % to 99 mol % terephthalic acid.

16. The method according to one of the preceding claims, characterized in that simultaneously with the crystallization step c) heat-up to a suitable temperature for solid phase polycondensation takes place.

17. The method according to one of the preceding claims, characterized in that porous granulates are produced, into which preferably in step a) and/or step b), a foaming agent is added to the polymer melt.
